(19) United States
(12) Patent Application Publication
(10) Pub. No.: US 2014/0079959 A1
(43) Pub. Date: Mar. 20, 2014

(54) Battery for Motorized Vehicles

(71) Applicant: Reginald Leonard Nicoson, Windsor, CO (US)

(72) Inventor: Reginald Leonard Nicoson, Windsor, CO (US)

(21) Appl. No.: 13/623,090

(22) Filed: Sep. 19, 2012

(51) Int. Cl. H01M 10/42

(52) U.S. Cl. 429/7

(57) ABSTRACT

A light-weight electrochemical battery for use in motorsports vehicles, an embodiment of this invention, includes features to cost-effectively protect the battery's cells from over-charging, and reduce manufacturing effort by solving mechanical, thermal and electrical needs with common structures, as well as reducing the number of manufactured parts by using interchangeable components.

In this manner, a light-weight electrochemical battery can be designed and manufactured at a cost effective price to compete as a replacement for the traditional lead-acid battery.

### BACKGROUND OF THE INVENTION

The present invention relates to lithium or other light-weight electrochemical cell batteries for motorized vehicles. More particularly, it is related to the design and design for manufacturing of such batteries,

A light-weight rechargeable battery, with a low self-discharge rate, would, be an ideal power source for motorsport vehicles. The battery itself may consist of a number of individual battery cells combined within the battery pack to provide a desired voltage. A Lithium-Iron-Phosphate battery with four cells has a design voltage of 13.4V, by way of non-limiting example.

Lithium-Iron-Phosphate batteries, like most lithium ion batteries, need circuitry to prevent overcharging the individual battery cells, by disabling or limiting the charging of the battery cells. Over-charging a cell causes heating in the cell and leads to permanent damage due to cell layer separation. The typical lithium battery includes a disconnect switch, in the form of a MOSFET, that disables/enables charge current flow into the cells. The inclusion of this switch in an extremely high current output battery, like a motorized vehicle battery, is very expense and takes up space within the battery pack.

Many patents on lithium batteries and battery management systems exist. However, existing patents focus on the microprocessor control of lithium cell balancing and charging protection. Specifically, previous patents detail electronic methods for transferring charge from one cell to another or wasting cells energy in the form of heat with a resistor. Other patents deal with cell or pack over-charging by disconnecting the cell or pack from the charging source with MOSFETs acting as a switch. U.S. Pat. No. 5,557,188 shows a micro-processor based battery management system that protects against overvoltage, but does so by disconnecting the battery. It also refers to the positive terminal of battery coupled with appropriate control circuitry, but does not mention an anti-rotation mechanism incorporated into the battery terminal and circuit board, nor does it mention the terminal as a thermal pathway. U.S. Pat. No. 8,168,317 shows a mechanical means for disconnecting cells when exposed to over-charging. Similarly, U.S. Pat. No. 8,134,340 shows a micro-processor based battery management system that can disconnect the charge discharge current path to a battery pack with an electro-mechanical relay. U.S. Pat. No. 7,969,119 relates to an overvoltage protection system which acts to atop the charging device, the external source of power to the battery. According to Japanese Patent Publication No. 2000-166107, overvoltage protection is duplicated by a first protection function operating an FET, and a second protection function operating a temperature fuse, to again discount the charging source. U.S. Pat. No. 6,518,731 details the use of a MOSFET connected across a battery and in parallel with a charger, whereas MOSFET is used as a shunt to regulate the voltage out of the charger. The MOSFET in this patent relates to the charging system voltage control and overvoltage protection, but is not an integral part of the battery and its independent battery cell protection.

U.S. Pat. No. 6,010,800 claims an apparatus for transferring heat from a battery cell terminal through a thermal conduit, like a heat pipe, to a heat sink. The focus of this patent is on the method of transferring heat external to the battery.

To the applicant's knowledge there is not an equivalent battery design in existence.

### DESCRIPTION OF THE DRAWINGS

FIG. 1 is a cross-sectional view of the battery.

FIG. 2 is a detailed view of the battery terminals.

FIG. 3 is a detailed view of the electronic circuit board.

FIG. 4 is a schematic of the electronics circuit hoard's MOSFET cell overvoltage protection circuits.

FIG. 5 is a drawing illustrating the battery's interchangeable end caps.

### DETAILED DESCRIPTION OF THE INVENTION

The following detailed description of preferred embodiments refers to the accompanying drawings, which illustrate specific embodiments of the invention. Other embodiments having different structures and operations do not depart from the scope of the present invention.

The present invention may be applied to lithium or other light-weight electrochemical cell batteries in many different configurations including, but not limited to, four cells in series and multiple in parallel. An embodiment of the present invention takes the form of an apparatus that incorporates electrochemical cells, an electronic circuit board, battery terminals and battery case structures.

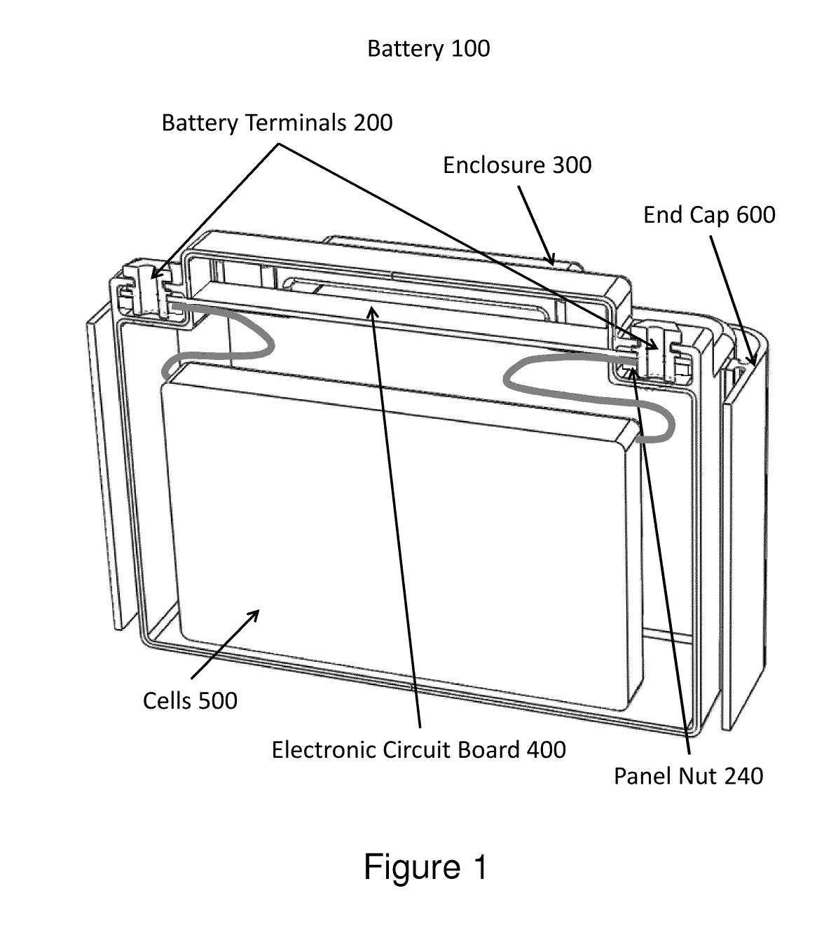

Referring to FIG. 1, there is illustrated a battery 100 with a light-weight enclosure 300. The two battery terminals 200, a positive terminal and a negative terminal, are positioned on the top of the enclosure at opposite ends of the battery. The electronic circuit board 400 is fastened to the positive terminal and the negative terminal. The electronic circuit board has electronic circuits designed to balance the charge of the multiple cell battery pack as well as protect the cells for being over-charged. The multiple cells 500 in a series and parallel configuration are bond together to create the battery pack. The battery packs positive pole is connected to the battery positive terminal on the bottom side of the electronic, circuit board with heavy gauge wire. The battery packs negative pole is connected to the battery negative terminal on the bottom side of the electronic circuit board with heavy gauge wire. The inter-cell terminals; between the first and second cell, second and third cell, and third and fourth cells are also connected to the electronic circuit hoard, with small gauge wire, but not shown.

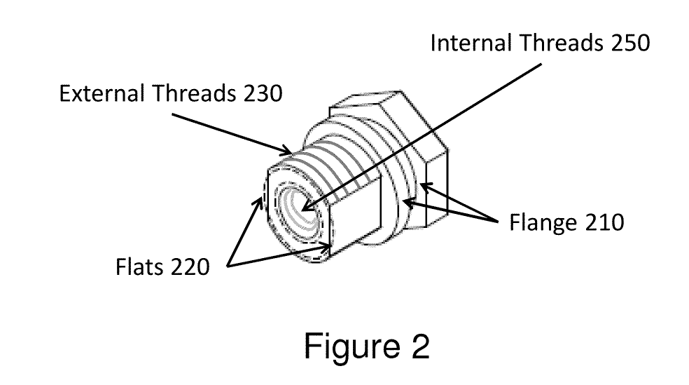

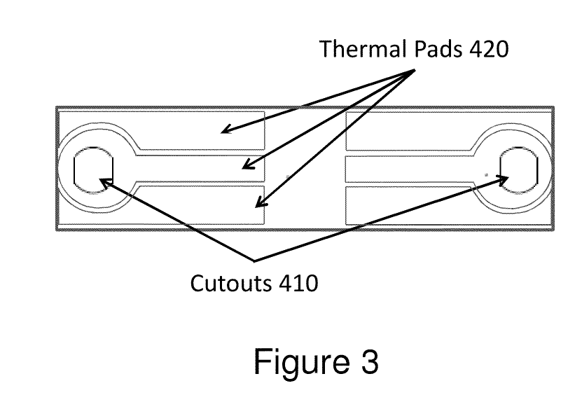

The positive battery terminal and the negative battery terminal 200 included in the embodiment of this invention are electrically and thermally conductive metallic fittings with interior threads on the portion exposed on the outside of the case and exterior threads on the portion inside of the case. The positive and negative terminals have flanges on both the exterior surface and the interior surface where the battery terminal passes through the battery case. Now, referring to FIG. 2, the flanges 210 provide rigidity and help seal the penetration thru the case making it waterproof. The battery terminal's external threads 230 are milled off on opposing sides to form two flat surfaces 220. The battery electronic circuit board in FIG. 3 has cutouts 410 at each end that match the profile of the battery terminals. The lower portion of the battery terminals passes through the electronic circuit board cutouts, where a panel nut 240, shown in FIG. 1, is threaded onto the battery terminals on the underside of the electronic circuit board to securely fasten the circuit board to the battery terminals. The flats on the battery terminals when mated with the matching cutout on the circuit board and securely fastened hold the battery terminals from rotating when torque is applied to the battery terminal's internal threads 250. The battery terminal's internal threads, and a screw threaded into said threads, fastens the vehicles battery cable to the battery.

A commonly used method to balance cell charge is to use a transistor or MOSFET in series with a resistor to drain off current from the cells with the highest charge levels. The excess energy of the cells with the disproportionately high charge levels is wasted in the form of heat. A common method to protect cells from over-charging is to disconnect the cell or pack of cells when the voltage level of any individual cell exceeds the upper voltage limit. That type of circuit uses MOSFETs as electrical switches to disconnect the cell or pack of cells from the electrical source. That type of overvoltage protection circuitry has a large physical size and is very costly. Additionally, that type of circuit is fail-open, meaning if the circuit fails the MOSFETs go to an oft state and the electrical source or load is disconnected. This type of circuitry may or may not be packaged inside the battery pack. Another type of overvoltage protection used during charging is a shunt regulator at the output of the charger. The shunt regulator is designed for the specific charger and as such should be considered a part of the charger, not part of the battery. For batteries used in motor vehicle applications, in particular, batteries for motorsport vehicles, the battery must be a rugged, sealed, self-monitoring and self-protecting.

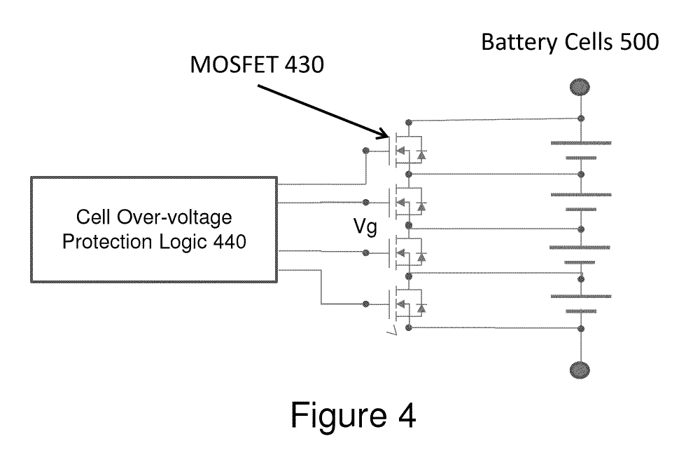

The electronic circuit board 400 included in the embodiment of this invention is enclosed in the battery, The electronic circuit board as shown in FIG. 1 includes electronic circuits designed to protect the individual cells from being over-charged. FIG. 4 shows the schematic of the cell over-charge protection. The novel method for cell charge level protection included in the embodiment of this invention is the use of a MOSFET 430 connected directly across each cell without a resistor in series with the MOSFETs. When a cell's charge level is disproportionately high as compared to a neighboring cell or the cell's voltage is greater than the cells designed maximum operating voltage, the cell overvoltage protection logic 440 will drive the MOSFET gate voltage (Vg) to a value just over the MOSFET's specified threshold voltage. In this condition, the MOSFET will be operating in the triode mode (linear region) a conductive state with a high resistance. In this state the current will flow from the cell positive terminal into the source of the MOSFET, then out the MOSFET drain to the cell's negative terminal. The excess energy of the cell will be dissipated in the form of heat in the MOSFET due to the current times resistance (I2R) losses. Modern MOSFETs are capable of operating at extremely high temperatures and are very cost effective. MOSFETs can be less expensive than power resistors based on cost per watt of heat dissipated. This concept, while simple, was never considered in prior act due to the temperature and cost limitation of MOSFETs.

The MOSFETs 430 are surface mounted on large copper thermal pads 420 which extend from beneath MOSFET drain to the end of the circuit board near the cutout for the battery terminal. The copper pads acts as thermal conduit to conduct heat away from the MOSFETs to the ends of the circuit board were the battery terminals 200 mate with the circuit board. The circuit board is clamped between the battery terminal flange on the top side of the terminal board and the panel nut on the bottom side of the terminal board. The large surface area of the flange and panel nut, as well as the compression forces, ensures good thermal and electrical conductivity between the circuit board and the battery terminal. Heat is conducted through the brass, or other highly conductive metal battery terminal to the top surfaces of the battery terminal which are outside the battery enclosure. The vehicle's battery cables, although not an embodiment of this invention, help to conduct heat away from the battery. The positive and negative battery terminals on opposing ends are the circuit board conduct the majority of heat generated by the MOSFETs to the exterior of the battery case.

This method of fastening the circuit board, as described above, provides a secure means of mechanically mounting the circuit board to the battery, protecting it from mechanical stresses such as shock and vibration. This method of fastening the circuit board also provides an electrical connection from the battery positive and negative terminals to the electronic circuit board.

it is known that lithium ion battery discharge current capability is affected by temperature. At lower temperatures, the discharge current capability is reduced, and at high temperatures the discharge current capabilities increases. A common solution for lithium batteries in extreme cold is to heat the battery prior to use. The electronic circuit board, an embodiment of this invention, and its heat generating MOSFETs could be used for such a purpose. A remote switch connected to the electronic circuit board by one or two wires could activate the overvoltage protection logic, such that when the remote switch contact is closed the MOSFETs 430 are turned on. These MOSFETs are the same MOSFETs used in the cell overvoltage circuit in FIG. 4. When the MOSFETs are on, they conduct current from the cell through the MOSFET. The MOSFETs I2R losses would be the energy in the form heat to warm the cells. Moreover, as current passes through the cells to the MOSFETs the I2R losses within the cell also warm up the cells. After a short period, as measured in minutes, the cells internal temperature would have increased, thus increasing the cells available discharge current to a level that is sufficient to start the vehicle's engine.

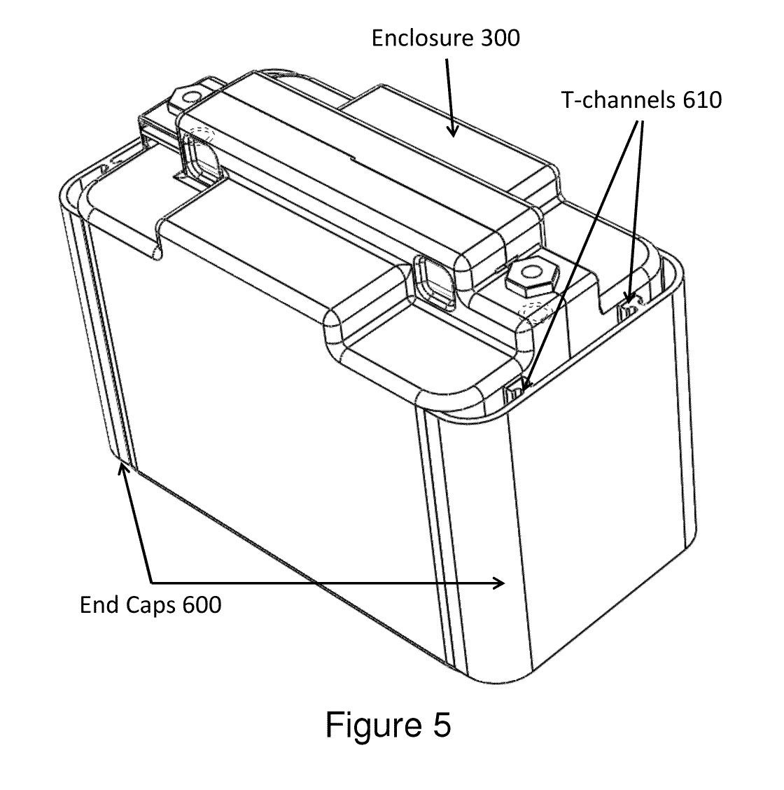

Referring now to FIG. 5, the isometric view of the battery case illustrates the use of interchangeable and removable structures that function as spacers, hereafter referred to as end caps 600, to increase the overall length and or height of the battery case. Lithium or other modern electrochemical cells are generally much smaller than the lead acid cells/battery they replace. From a manufacturing standpoint it is desirable to build higher volumes of less part numbers. But for retrofit applications the replacement battery needs to be the same or similar physical size as the original. The novel solution presented here, and an embodiment of this invention, is a separate end cap that can be installed on the ends of the battery enclosure to extend the length or height needed. The end caps are designed as a hollow structure to reduce the weight. The exterior surfaces are also designed to match the look and feel of the battery enclosure. The end caps can be affixed to the two short sides of the battery enclosure 300 with double-sided adhesive tape. The double-sided adhesive tape is applied to two “T” shaped channels 610 that run the length of the end cap.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, operations, elements, and/or components, but do not preclude the presence or addition of one or more other features, operations, elements, components, and/or groups thereof.

Although specific embodiments have been illustrated and described herein, it should be appreciated that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A battery for motorized vehicles, comprising:
Electrochemical cells in series and one or more cells in parallel;
Electronic circuit board with at least one MOSFET component connected to at least one of said cells and operable to dissipate charge of said cell;
A positive battery terminal and a negative battery terminal with said electronic circuit board fastened to each;
An enclosure with interchangeable and removable structures that function as spacers at the two ends of the battery;

2. The battery of claim 1, wherein said electronic circuit board and its said MOSFET protects said lithium cells from a disproportionately high charge level on a single cell as compared a neighboring cell or a cell voltage greater than the cell design limits, by dissipating said cell's energy in the form of I2R losses through said MOSFET operating in the triode state connected in parallel with said cell.

3. The battery of claim 1, wherein said positive battery terminal and negative battery terminal is fastened to the electronic circuit board to facilitate the thermal conduction of the heat generated by the MOSFETs of claim 2 to the battery terminals surfaces on the exterior of the battery.

4. The battery terminals of claim 3 have a cylindrical shape with external threads and two opposing flat sides which pass through a similar shape cutout in the electronic circuit board of claim 1 and fastened on the back side of the circuit board, such that said battery terminal is prevented from rotating due to torque applied at the battery terminal's internal screw threads.

5. The battery of claim 1, wherein the enclosure includes interchangeable and removable structures which function as spacers on the two ends of the short side of the battery, to increase the overall length and or height of the battery enclosure.

6. The electronic circuit board in claim 2, wherein said MOSFETs can be controlled manually from an external switch, whereby energy losses in the MOSFETs generate heat to increase the temperature of the battery cells of claim 1.
